(19) United States
(12) Patent Application Publication
(10) Pub. No.: US 2024/0138411 A1
(43) Pub. Date: May 2, 2024

(54) METHOD OF INHIBITING FLOWERING OF SUGARCANE

(71) Applicant: CORTEVA AGRISCIENCE LLC, INDIANAPOLIS, IN (US)

(72) Inventors: NELSON M. CARRANZA GARZON, IBAGUE (CO); MAURICIO MORELL, CARMEL, IN (US); LUCAS PERIM, JARDINÓPOLIS (BR); CAIO VITAGLIANO SANTI ROSSI, UBERLANDIA (BR)

(73) Assignee: CORTEVA AGRISCIENCE LLC, INDIANAPOLIS, IN (IN)

(21) Appl. No.: 18/554,687

(22) PCT Filed: Apr. 13, 2022
(86) PCT No.: PCT/US2022/024527

§ 371 Date: Oct. 10, 2023

Related U.S. Application Data
(60) Provisional application No. 63/175,652, filed on Apr. 16, 2021.

(51) Int. Cl. A01N 43/40; A01P 21/00

(52) U.S. Cl. CPC A01N 43/40; A01P 21/00

(57) ABSTRACT

A new method, comprising treating sugarcane with florpyrauxifen-benzyl during the sugarcane flowering induction period, increases sugar production and extraction efficiency.

### BACKGROUND

Sugarcane is important because of its many uses including the production of molasses, brown sugar, sugar, ethanol, and alcoholic beverages. Sugarcane is also used for animal feed and sugar waste may be converted to fertilizer and fuel.

To maximize production of sugar from sugarcane it is necessary to maximize the amount of sugar produced by the plants. One method of maximizing sugar production is to inhibit flowering since flowering is known to reduce both the amount and the quality of sugar produced by the plant. In addition, stalks of sugarcane which have flowered possesses a consistency and texture which makes extraction of sugar less efficient. Since flowering inhibition improves both sugar quality and sugar extraction efficiency, there is a need for compounds and methods that inhibit sugarcane flowering.

One method of sugarcane flowering inhibition involves treating sugarcane with 2-chloroethylphosphonic acid, also known as ethephon (Ethrel®), a well-known plant growth regulator, which is typically applied at a rate from 400-1000 grams/hectare. The use of ethephon has been described in U.S. Pat. No. 6,080,700 and in PCT application WO 00/18235 A1. However, there remains an ongoing need for new treatments having greater efficacy and reduced environmental impact.

### BRIEF DESCRIPTION

It has now been surprisingly found that florpyrauxifen, or agriculturally acceptable salts or esters thereof, may be employed as a sugarcane flowering inhibitor. Applying florpyrauxifen to sugarcane at rates from about 2 to about 20 grams of active ingredient per hectare (g ai/ha) has now been shown to inhibit sugarcane flowering resulting in greater sugar production. The low use rate of florpyrauxifen (2-20 g ai/ha) provides a method with a greatly reduced environmental impact. A preferred agriculturally acceptable ester of florpyrauxifen is florpyrauxifen-benzyl. Florpyrauxifen, a synthetic auxin, also has a different mode of action than the standard treatment—ethephon.

Certain aspects provide herein include a method of increasing the weight of harvested sugarcane per hectare. Applying an effective amount of florpyrauxifen, or agriculturally acceptable salts or esters thereof, during the period of sugarcane flower induction according to the methods described herein, may result in an increase of harvested sugarcane of from 5-25 tons per hectare compared to untreated sugarcane.

As used herein, agriculturally acceptable salts and esters refer to salts and esters of florpyrauxifen that exhibit herbicidal activity, or that are or can be converted in plants, water, or soil, to florpyrauxifen. Exemplary agriculturally acceptable and esters are those that are or can be hydrolyzed, oxidized, metabolized, or otherwise converted, e.g., in plants, water, or soil, to florpyrauxifen acid which, depending upon the pH, may be in the dissociated or undissociated form.

Certain aspects provided herein include methods for producing sugarcane with reduced fiber content, increasing sugarcane processing efficiency and lowering processing costs.

An aspect provided herein includes a new method of increasing sugar production from sugarcane.

An aspect provided herein includes a new method of substantially inhibiting flower production in sugarcane.

An aspect provided herein includes a new method of preventing flower production in sugarcane.

An aspect provided herein includes a new method for producing sugarcane of improved quality for processing and sugar extraction in a sugar processing mill.

An aspect provided herein includes a new method of sugarcane flowering inhibition with a reduced environmental impact.

### DETAILED DESCRIPTION

Florpyrauxifen and florpyrauxifen-benzyl and their use are described in the Pesticide Manual 18^{th} Edition, 2016, British Crop Protection Council, and in J. Epp et al. Bioorg. Med. Chem., 2016, 24, 362-371. The compound is used for the post-emergent control of grass, broad-leaved and sedge weeds in rice; control of broad-leaved weeds in pastures.

Ethephon and its use is described in the Pesticide Manual, 18^{th} Edition, British Crop Protection Council, and in United States patents U.S. Pat. Nos. 3,879,188; 3,896,163; 3,897,486; 6,080,700. The compound is a systemic plant growth regulator that is metabolised or decomposed to ethylene, the biologically active species.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Certain aspects provided herein include a method of substantially inhibiting flowering in sugarcane. The method comprises applying a composition comprising florpyraxuifen or an agriculturally acceptable salt or ester thereof during a period of flowering induction of sugarcane. The term “substantially inhibiting flowering” means that a majority of treated sugarcane plants do not flower.

The period of flowering induction is generally when the sugarcane is exposed to sunlight from 10 to 14 hours per day, preferably from 11 to 13 hours per day. Generally, the period of flowering induction will begin after the summer solstice (June in the northern hemisphere December in the southern hemisphere), when the number of hours of sunlight per day is decreasing. In the northern hemisphere the induction period may be during July-August. In the southern hemisphere the induction period may be between February-March. The period of flowering induction is about 45 days.

The sugarcane may comprise varieties RB85 5035, IACSP91 1099, and CTC 22. Other varieties may be used as well.

In order to explore the activity of florpyrauxifen as flowering inhibitor in sugarcane, field studies were carried out. Florpyrauxifen-benzyl was tested at rates from 2 to 20 grams active ingredient per hectare (g ai/ha) and compared to Ethrel® 720 (Bayer), the standard treatment. The flowering inhibition effect was assessed by checking the floral induction in sugarcane through the percentage scale recommended by UFSCar (Federal University of Sao Carlos, Sao Paulo, Brazil). Surprisingly, the results demonstrated that florpyrauxifen-benzyl applied at rates from 2 to 20 g ai/ha was an excellent sugarcane flowering inhibitor. It performed as well as or better than the standard treatment 60 to 150 days after application.

Florpyrauxifen, or an agriculturally acceptable salt or ester thereof may be applied via aerial application.

### Experimental Results

Four trials were carried out in sugarcane where florpyrauxifen-benzyl (Rinskor®), applied at a rate of 2 to 20 g ai/ha, was compared to ethephon (Ethrel® 720) applied at a rate of 475 g ai/ha. Control plots of untreated sugarcane were also evaluated. Rinskor® and Ethrel® 720 were diluted in water and a single application for each study (backpack sprayer) was performed delivering 50 L of spray solution per ha at the reproductive stage of sugarcane and at a maximum 150 days before harvest. The activity of florpyrauxifen-benzyl as a flowering inhibitor was measured via assessments (Scale of flowering inhibition—see chart 1) performed at 0, 14, 30, 45, 60, 75, 90, 120, 150 days after application, or up to harvest time. The assessments were measured in sugarcane stems, rating the flowering induction according to the UFSCar scale shown below. Significance of treatment effect was evaluated with F-approximate test (α=0.1) and least square means from different treatments were compared with Tukey's test.

CHART 1
Sugarcane Floral Induction

[symbol]

| Floral Induction | Percentage | Note |
|---|---|---|
| Nothing | 0% | a 1/1 |
| Up to 1 cm | 15% | b 2/1 |
| 1 cm to 3 cm | 30% | c 3/1 |
| Above 3 cm | 50% | d 4/1 |
| With panicle emission between 1 and 25% | 80% | e 4/2 |
| With panicle emission between 26 and 70% | 90% | f 4/3 |
| With panicle emission over 70% | 100% | g 4/4 |

Floral Induction Scale used in the evaluation of the induction of flowering of sugarcane, as recommended by
UFSCar (Federal University of São Carlos, São Paulo, Brazil). Percentage scale of floral induction in sugarcane.

TABLE 1
Referring to Floral Induction Scale in percentage (Average from 10 stems of sugarcane)
and Frequency displayed by each treatment (% Percentage).

| | % Referring to | | 1/1 | 2/1 | 3/1 | 4/1 | 4/2 | 4/3 | 4/4 |
|---|---|---|---|---|---|---|---|---|---|
| Treatment @g/ha | Scale | Note | (0%) | (15%) | (30%) | (50%) | (80%) | (90%) | (100%) |
| | 75 DAA | | | | | | | | |
| Rinskor@2 | 13.5 | AB | 12.5 | 85.0 | 2.5 | 0.0 | 0.0 | 0.0 | 0.0 |
| Rinskor@5 | 14.6 | B | 7.5 | 87.5 | 5.0 | 0.0 | 0.0 | 0.0 | 0.0 |
| Rinskor@10 | 11.3 | AB | 25.0 | 75.0 | 0.0 | 0.0 | 0.0 | 0.0 | 0.0 |
| Rinskor@15 | 10.1 | A | 32.5 | 67.5 | 0.0 | 0.0 | 0.0 | 0.0 | 0.0 |
| Rinskor@20 | 10.5 | A | 30.0 | 70.0 | 0.0 | 0.0 | 0.0 | 0.0 | 0.0 |
| ETHREL720@475 | 12.4 | AB | 17.5 | 82.5 | 0.0 | 0.0 | 0.0 | 0.0 | 0.0 |
| UNTREATED | 10.9 | A | 27.5 | 72.5 | 0.0 | 0.0 | 0.0 | 0.0 | 0.0 |
| | 90 DAA | | | | | | | | |
| Rinskor@2 | 13.1 | A | 12.5 | 87.5 | 0.0 | 0.0 | 0.0 | 0.0 | 0.0 |
| Rinskor@5 | 11.3 | A | 25.0 | 75.0 | 0.0 | 0.0 | 0.0 | 0.0 | 0.0 |
| Rinskor@10 | 14.3 | A | 7.5 | 90.0 | 2.5 | 0.0 | 0.0 | 0.0 | 0.0 |
| Rinskor@15 | 13.9 | A | 7.5 | 92.5 | 0.0 | 0.0 | 0.0 | 0.0 | 0.0 |
| Rinskor@20 | 13.5 | A | 15.0 | 80.0 | 5.0 | 0.0 | 0.0 | 0.0 | 0.0 |
| ETHREL720@475 | 13.1 | A | 20.0 | 72.5 | 7.5 | 0.0 | 0.0 | 0.0 | 0.0 |
| UNTREATED | 15.0 | A | 7.5 | 85.0 | 7.5 | 0.0 | 0.0 | 0.0 | 0.0 |
| | 120 DAA | | | | | | | | |
| Rinskor@2 | 13.9 | AB | 7.5 | 92.5 | 0.0 | 0.0 | 0.0 | 0.0 | 0.0 |
| Rinskor@5 | 12.8 | A | 15.0 | 85.0 | 0.0 | 0.0 | 0.0 | 0.0 | 0.0 |
| Rinskor@10 | 13.9 | AB | 7.5 | 92.5 | 0.0 | 0.0 | 0.0 | 0.0 | 0.0 |
| Rinskor@15 | 13.9 | AB | 7.5 | 92.5 | 0.0 | 0.0 | 0.0 | 0.0 | 0.0 |
| Rinskor@20 | 12.8 | A | 15.0 | 85.0 | 0.0 | 0.0 | 0.0 | 0.0 | 0.0 |
| ETHREL720@475 | 18.1 | B | 0.0 | 87.5 | 10.0 | 0.0 | 2.5 | 0.0 | 0.0 |
| UNTREATED | 18.0 | B | 0.0 | 80.0 | 20.0 | 0.0 | 0.0 | 0.0 | 0.0 |

/Values followed by different letters are significantly different by Tukey's test (α = 0.1).

TABLE 2
Referring to Floral Induction Scale in percentage (Average from 10 stems of sugarcane)
and Frequency displayed by each treatment (% Percentage).

| | % Referring to | | 1/1 | 2/1 | 3/1 | 4/1 | 4/2 | 4/3 | 4/4 |
|---|---|---|---|---|---|---|---|---|---|
| Treatment @g/ha | Scale | Note | (0%) | (15%) | (30%) | (50%) | (80%) | (90%) | (100%) |
| | 75 DAA | | | | | | | | |
| Rinskor@2 | 1.1 | A | 92.5 | 7.5 | 0.0 | 0.0 | 0.0 | 0.0 | 0.0 |
| Rinskor@5 | 0.8 | A | 95.0 | 5.0 | 0.0 | 0.0 | 0.0 | 0.0 | 0.0 |
| Rinskor@7 | 0.8 | A | 95.0 | 5.0 | 0.0 | 0.0 | 0.0 | 0.0 | 0.0 |
| Rinskor@10 | 0.4 | A | 97.5 | 2.5 | 0.0 | 0.0 | 0.0 | 0.0 | 0.0 |
| Rinskor@15 | 1.1 | A | 92.5 | 7.5 | 0.0 | 0.0 | 0.0 | 0.0 | 0.0 |
| Rinskor@20 | 0.8 | A | 95.0 | 5.0 | 0.0 | 0.0 | 0.0 | 0.0 | 0.0 |
| ETHREL720@475 | 0.8 | A | 95.0 | 5.0 | 0.0 | 0.0 | 0.0 | 0.0 | 0.0 |
| UNTREATED | 1.1 | A | 92.5 | 7.5 | 0.0 | 0.0 | 0.0 | 0.0 | 0.0 |
| | 90 DAA | | | | | | | | |
| Rinskor@2 | 60.3 | C | 0.0 | 0.0 | 20.0 | 32.5 | 47.5 | 0.0 | 0.0 |
| Rinskor@5 | 43.5 | AB | 0.0 | 0.0 | 32.5 | 67.5 | 0.0 | 0.0 | 0.0 |
| Rinskor@7 | 44.8 | AB | 0.0 | 0.0 | 37.5 | 55.0 | 7.5 | 0.0 | 0.0 |
| Rinskor@10 | 37.4 | A | 0.0 | 7.5 | 50.0 | 42.5 | 0.0 | 0.0 | 0.0 |
| Rinskor@15 | 39.8 | AB | 0.0 | 15.0 | 25.0 | 60.0 | 0.0 | 0.0 | 0.0 |
| Rinskor@20 | 46.0 | AB | 0.0 | 5.0 | 30.0 | 52.5 | 12.5 | 0.0 | 0.0 |
| ETHREL720@475 | 51.8 | BC | 0.0 | 0.0 | 25.0 | 52.5 | 22.5 | 0.0 | 0.0 |
| UNTREATED | 75.3 | D | 0.0 | 0.0 | 0.0 | 17.5 | 77.5 | 5.0 | 0.0 |
| | 120 DAA | | | | | | | | |
| Rinskor@2 | 95.8 | A | 0.0 | 0.0 | 0.0 | 0.0 | 5.0 | 32.5 | 62.5 |
| Rinskor@5 | 96.5 | AB | 0.0 | 0.0 | 0.0 | 0.0 | 7.5 | 20.0 | 72.5 |
| Rinskor@7 | 97.0 | AB | 0.0 | 0.0 | 0.0 | 0.0 | 5.0 | 20.0 | 75.0 |
| Rinskor@10 | 96.8 | AB | 0.0 | 0.0 | 0.0 | 0.0 | 10.0 | 12.5 | 77.5 |
| Rinskor@15 | 98.5 | AB | 0.0 | 0.0 | 0.0 | 0.0 | 0.0 | 15.0 | 85.0 |
| Rinskor@20 | 97.5 | B | 0.0 | 0.0 | 0.0 | 0.0 | 7.5 | 10.0 | 82.5 |
| ETHREL720@475 | 98.0 | AB | 0.0 | 0.0 | 0.0 | 0.0 | 2.5 | 15.0 | 82.5 |
| UNTREATED | 100.0 | C | 0.0 | 0.0 | 0.0 | 0.0 | 0.0 | 0.0 | 100.0 |

/Values followed by different letters are significantly different by Tukey's test (α = 0.1).

TABLE 3
Referring to Floral Induction Scale in percentage (Average from 10 stems of sugarcane)
and Frequency displayed by each treatment (% Percentage).

| | % Referring to | | 1/1 | 2/1 | 3/1 | 4/1 | 4/2 | 4/3 | 4/4 |
|---|---|---|---|---|---|---|---|---|---|
| Treatment @g/ha | Scale | Note | (0%) | (15%) | (30%) | (50%) | (80%) | (90%) | (100%) |
| | 90 DAA | | | | | | | | |
| Rinskor@2 | 0.0 | A | 100.0 | 0.0 | 0.0 | 0.0 | 0.0 | 0.0 | 0.0 |
| Rinskor@5 | 0.0 | A | 100.0 | 0.0 | 0.0 | 0.0 | 0.0 | 0.0 | 0.0 |
| Rinskor@7 | 0.0 | A | 100.0 | 0.0 | 0.0 | 0.0 | 0.0 | 0.0 | 0.0 |
| Rinskor@10 | 0.4 | A | 97.5 | 2.5 | 0.0 | 0.0 | 0.0 | 0.0 | 0.0 |
| Rinskor@15 | 0.0 | A | 100.0 | 0.0 | 0.0 | 0.0 | 0.0 | 0.0 | 0.0 |
| Rinskor@20 | 0.0 | A | 100.0 | 0.0 | 0.0 | 0.0 | 0.0 | 0.0 | 0.0 |
| ETHREL720@475 | 0.0 | A | 100.0 | 0.0 | 0.0 | 0.0 | 0.0 | 0.0 | 0.0 |
| UNTREATED | 3.4 | A | 82.5 | 12.5 | 5.0 | 0.0 | 0.0 | 0.0 | 0.0 |
| | 120 DAA | | | | | | | | |
| Rinskor@2 | 5.6 | A | 62.5 | 37.5 | 0.0 | 0.0 | 0.0 | 0.0 | 0.0 |
| Rinskor@5 | 6.9 | A | 62.5 | 32.5 | 2.5 | 2.5 | 0.0 | 0.0 | 0.0 |
| Rinskor@7 | 3.0 | A | 80.0 | 20.0 | 0.0 | 0.0 | 0.0 | 0.0 | 0.0 |
| Rinskor@10 | 4.1 | A | 72.5 | 27.5 | 0.0 | 0.0 | 0.0 | 0.0 | 0.0 |
| Rinskor@15 | 2.6 | A | 85.0 | 12.5 | 2.5 | 0.0 | 0.0 | 0.0 | 0.0 |
| Rinskor@20 | 3.0 | A | 80.0 | 20.0 | 0.0 | 0.0 | 0.0 | 0.0 | 0.0 |
| ETHREL720@475 | 1.5 | A | 90.0 | 10.0 | 0.0 | 0.0 | 0.0 | 0.0 | 0.0 |
| UNTREATED | 6.0 | A | 67.5 | 25.0 | 7.5 | 0.0 | 0.0 | 0.0 | 0.0 |
| | 150 DAA | | | | | | | | |
| Rinskor@2 | 3.0 | AB | 80.0 | 20.0 | 0.0 | 0.0 | 0.0 | 0.0 | 0.0 |
| Rinskor@5 | 1.9 | A | 87.5 | 12.5 | 0.0 | 0.0 | 0.0 | 0.0 | 0.0 |
| Rinskor@7 | 3.0 | AB | 80.0 | 20.0 | 0.0 | 0.0 | 0.0 | 0.0 | 0.0 |
| Rinskor@10 | 0.8 | A | 95.0 | 5.0 | 0.0 | 0.0 | 0.0 | 0.0 | 0.0 |
| Rinskor@15 | 1.9 | A | 87.5 | 12.5 | 0.0 | 0.0 | 0.0 | 0.0 | 0.0 |
| Rinskor@20 | 0.0 | A | 100.0 | 0.0 | 0.0 | 0.0 | 0.0 | 0.0 | 0.0 |
| ETHREL720@475 | 0.0 | A | 100.0 | 0.0 | 0.0 | 0.0 | 0.0 | 0.0 | 0.0 |
| UNTREATED | 8.3 | B | 50.0 | 45.0 | 5.0 | 0.0 | 0.0 | 0.0 | 0.0 |

/Values followed by different letters are significantly different by Tukey's test (α = 0.1).

TABLE 4
Referring to Floral Induction Scale in percentage (Average from 10 stems of sugarcane)
and Frequency displayed by each treatment (% Percentage).

| | % Referring to | | 1/1 | 2/1 | 3/1 | 4/1 | 4/2 | 4/3 | 4/4 |
|---|---|---|---|---|---|---|---|---|---|
| | Scale | Note | (0%) | (15%) | (30%) | (50%) | (80%) | (90%) | (100%) |
| Treatment @g/ha | 90 DAA | | | | | | | | |
| Rinskor@2 | 5.6 | B | 65.0 | 35.0 | 0.0 | 0.0 | 0.0 | 0.0 | 0.0 |
| Rinskor@4 | 1.1 | A | 87.5 | 12.5 | 0.0 | 0.0 | 0.0 | 0.0 | 0.0 |
| Rinskor@10 | 6.0 | B | 60.0 | 40.0 | 0.0 | 0.0 | 0.0 | 0.0 | 0.0 |
| Rinskor@15 | 2.6 | A | 82.5 | 17.5 | 0.0 | 0.0 | 0.0 | 0.0 | 0.0 |
| Rinskor@20 | 3.0 | B | 80.0 | 20.0 | 0.0 | 0.0 | 0.0 | 0.0 | 0.0 |
| ETHREL720@475 | 4.9 | B | 67.5 | 32.5 | 0.0 | 0.0 | 0.0 | 0.0 | 0.0 |
| UNTREATED | 33.5 | C | 7.5 | 20.0 | 35.0 | 37.5 | 0.0 | 0.0 | 0.0 |

/Values followed by different letters are significantly different by Tukey's test (α = 0.

As shown above in Tables 1-4, the flowering inhibition performance of florpyrauxifen-benzyl (Rinskor®) is equivalent to or better than the standard (Ethrel® 720) at 60 to 150 days after application.

The nature, scope, utility, and effectiveness of various aspects of the present disclosure have been described and exemplified in the foregoing specification. These examples are not intended to be limiting.

1. A method of substantially inhibiting flowering in sugarcane comprising applying a composition comprising florpyrauxifen or an agriculturally acceptable salt or ester thereof during the sugarcane flowering induction period.

2. The method of claim 1 wherein the florpyrauxifen or agriculturally acceptable salt or ester thereof is florpyrauxifen-benzyl

3. The method according to claim 1 wherein the flowering induction period has sunlight from 10 to 14 hours per day, preferably from 11 to 13 hours per day.

4. The method according claim 1 wherein the sugarcane variety comprises one or more of RB85 5035, IACSP91 1099, and CTC 22.

5. The method according to claim 1 wherein the florpyrauxifen is applied at a rate of from about 2 g ai/ha to about 20 g ai/ha.

6. The method according to claim 1 wherein from 5% to 30% of the treated sugarcane produces flowers.

7. The method according to claim 1 wherein the composition is applied by aerial application.

8. The method according claim 2 wherein the sugarcane variety comprises one or more of RB85 5035, IACSP91 1099, and CTC 22.

9. The method according to claim 2 wherein the florpyrauxifen is applied at a rate of from about 2 g ai/ha to about 20 g ai/ha.

10. The method according to claim 2 wherein from 5% to 30% of the treated sugarcane produces flowers.

11. The method according to claim 2 wherein the composition is applied by aerial application.

12. The method according claim 3 wherein the sugarcane variety comprises one or more of RB85 5035, IACSP91 1099, and CTC 22.

13. The method according to claim 3 wherein the florpyrauxifen is applied at a rate of from about 2 g ai/ha to about 20 g ai/ha.

14. The method according to claim 3 wherein from 5% to 30% of the treated sugarcane produces flowers.

15. The method according to claim 3 wherein the composition is applied by aerial application.
